(19) United States
(12) Patent Application Publication
(10) Pub. No.: US 2026/0231169 A1
(43) Pub. Date: Aug. 6, 2026

(54) DOWNLINK CONTROL INFORMATION SIGNALING FOR FLEXIBLE SPECTRUM INTEGRATION AND CARRIER AGGREGATION CONFIGURATIONS

(71) Applicant: QUALCOMM Incorporated, San Diego, CA (US)

(72) Inventors: Javier RODRIGUEZ FERNANDEZ, San Diego, CA (US); Kianoush HOSSEINI, San Diego, CA (US); Kazuki TAKEDA, Minato-ku (JP)

(21) Appl. No.: 19/044,370

(22) Filed: Feb. 3, 2025

(51) Int. Cl. H04W 72/231; H04L 1/00; H04W 72/0446; H04W 72/0453; H04W 72/12

(52) U.S. Cl. CPC H04W 72/231; H04L 1/0003; H04W 72/0446; H04W 72/0453; H04W 72/12

(57) ABSTRACT

Various aspects of the present disclosure generally relate to wireless communication. In some aspects, a user equipment (UE) may receive configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA. The UE may receive a physical downlink control channel communication that includes DCI having the first DCI format or DCI having the second DCI format. The UE may communicate with a network node in accordance with the DCI. Numerous other aspects are described.

### FIELD OF THE DISCLOSURE

Aspects of the present disclosure generally relate to wireless communication and specifically relate to techniques, apparatuses, and methods associated with downlink control information signaling for flexible spectrum integration and carrier aggregation configurations.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A transport block (TB) in wireless communications is a smallest unit of data that can be processed and transmitted over an air interface. Carrier aggregation (CA) is a technique that combines multiple frequency bands (carriers) to increase the overall bandwidth available for data (TB) transmission. Carrier aggregation may allow for higher data rates and improved network performance by enabling devices to simultaneously transmit and receive data across multiple frequency bands. Flexible spectrum integration (FSI) is a concept that enables dynamic and efficient use of available spectrum resources across different radio access technologies and frequency bands. FSI may allow networks to adaptively allocate and reallocate spectrum based on traffic demands and network conditions, thereby improving overall spectrum utilization and network performance. In modern wireless communications, these concepts can work together to enable efficient data transmission and spectrum utilization. When a device is to transmit data, the device may be organized into one or more transport blocks, which serve as the fundamental units of data transmission. These transport blocks are then transmitted across one or more component carriers (CCs), which are individual frequency bands that can be combined using CA to achieve higher data rates. The implementation of FSI enhances this process by dynamically managing how these CCs are utilized, allowing the network to adaptively allocate spectrum resources in accordance with current conditions and demands. For example, if a device is experiencing high data demands, FSI can enable the network to implement CA by combining multiple CCs, each carrying its own TBs, to provide increased bandwidth and improved performance. This interconnected system may allow wireless networks to efficiently handle varying data requirements while maximizing the use of available spectrum resources.

### SUMMARY

In some aspects, a method of wireless communication performed by a user equipment (UE) includes receiving configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA; receiving a physical downlink control channel (PDCCH) communication that includes DCI having the first DCI format or DCI having the second DCI format; and communicating with a network node in accordance with the DCI.

In some aspects, a method of wireless communication performed by a network node includes transmitting configuration information that indicates a first DCI format and a second DCI format, wherein the first DCI format is configured to indicate only one of FSI or CA and the second DCI format is configured to indicate both FSI and CA; transmitting a PDCCH communication that includes DCI having the first DCI format or DCI having the second DCI format; and communicating with a UE in accordance with the DCI.

In some aspects, an apparatus configured for wireless communication includes one or more memories comprising processor-executable instructions; and one or more processors configured to execute the processor-executable instructions and cause the apparatus to: receive configuration information that indicates a first DCI format and a second DCI format, wherein the first DCI format is configured to indicate only one of FSI or CA and the second DCI format is configured to indicate both FSI and CA; receive a PDCCH communication that includes DCI having the first DCI format or DCI having the second DCI format; and communicate with a network node in accordance with the DCI.

In some aspects, an apparatus configured for wireless communication includes one or more memories comprising processor-executable instructions; and one or more processors configured to execute the processor-executable instructions and cause the apparatus to: transmit configuration information that indicates a first DCI format and a second DCI format, wherein the first DCI format is configured to indicate only one of FSI or CA and the second DCI format is configured to indicate both FSI and CA; transmit a PDCCH communication that includes DCI having the first DCI format or DCI having the second DCI format; and communicate with a UE in accordance with the DCI.

In some aspects, a non-transitory computer-readable medium storing a set of instructions for wireless communication includes one or more instructions that, when executed by one or more processors of a UE, cause the UE to: receive configuration information that indicates a first DCI format and a second DCI format, wherein the first DCI format is configured to indicate only one of FSI or CA and the second DCI format is configured to indicate both FSI and CA; receive a PDCCH communication that includes DCI having the first DCI format or DCI having the second DCI format; and communicate with a network node in accordance with the DCI.

In some aspects, a non-transitory computer-readable medium storing a set of instructions for wireless communication includes one or more instructions that, when executed by one or more processors of a network node, cause the network node to: transmit configuration information that indicates a first DCI format and a second DCI format, wherein the first DCI format is configured to indicate only one of FSI or CA and the second DCI format is configured to indicate both FSI and CA; transmit a PDCCH communication that includes DCI having the first DCI format or DCI having the second DCI format; and communicate with a UE in accordance with the DCI.

In some aspects, an apparatus for wireless communication includes means for receiving configuration information that indicates a first DCI format and a second DCI format, wherein the first DCI format is configured to indicate only one of FSI or CA and the second DCI format is configured to indicate both FSI and CA; means for receiving a PDCCH communication that includes DCI having the first DCI format or DCI having the second DCI format; and means for communicating with a network node in accordance with the DCI.

In some aspects, an apparatus for wireless communication includes means for transmitting configuration information that indicates a first DCI format and a second DCI format, wherein the first DCI format is configured to indicate only one of FSI or CA and the second DCI format is configured to indicate both FSI and CA; means for transmitting a PDCCH communication that includes DCI having the first DCI format or DCI having the second DCI format; and means for communicating with a UE in accordance with the DCI.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of physical channels and reference signals in a wireless network.

FIG. 4 is a diagram illustrating an example of downlink control information signaling for flexible spectrum integration and carrier aggregation configurations.

FIG. 5 is a diagram illustrating an example of transport block to subband group mapping for flexible spectrum integration.

FIG. 6 is a flowchart of an example method of wireless communication.

FIG. 7 is a flowchart of an example method of wireless communication.

FIG. 8 is a diagram illustrating an example of an implementation of code and circuitry for a communications device.

FIG. 9 is a diagram illustrating an example of an implementation of code and circuitry for a communications device.

### DETAILED DESCRIPTION

A transport block (TB) in wireless communications is a smallest unit of data that can be processed and transmitted over an air interface. Carrier aggregation (CA) is a technique that combines multiple frequency bands (carriers) to increase the overall bandwidth available for data (TB) transmission. Carrier aggregation may allow for higher data rates and improved network performance by enabling devices to simultaneously transmit and receive data across multiple frequency bands. Flexible spectrum integration (FSI) is a concept that enables dynamic and efficient use of available spectrum resources across different radio access technologies and frequency bands. FSI may allow networks to adaptively allocate and reallocate spectrum based on traffic demands and network conditions, thereby improving overall spectrum utilization and network performance.

In modern wireless communications, these concepts can work together to enable efficient data transmission and spectrum utilization. When a device is to transmit data, the device may be organized into one or more transport blocks, which serve as the fundamental units of data transmission. These transport blocks are then transmitted across one or more component carriers (CCs), which are individual frequency bands that can be combined using CA to achieve higher data rates. The implementation of FSI enhances this process by dynamically managing how these CCs are utilized, allowing the network to adaptively allocate spectrum resources in accordance with current conditions and demands. For example, if a device is experiencing high data demands, FSI can enable the network to implement CA by combining multiple CCs, each carrying its own TBs, to provide increased bandwidth and improved performance. This interconnected system may allow wireless networks to efficiently handle varying data requirements while maximizing the use of available spectrum resources.

Downlink control information (DCI), transmitted from a network node to a user equipment (UE), may include FSI data or CA data. In a first example, the DCI may have a first DCI format that enables the DCI to include only one of FSI data or CA data. In another example, the DCI may have a second DCI format that enables the DCI to include FSI data and CA data. In some cases, the UE may receive DCI that includes at least one of FSI data or CA data, but may not be configured with information that enables the UE to determine whether the DCI has the first DCI format or the second DCI format. This may negatively impact the UE and may negatively impact wireless communications between the UE and the network node. For example, in accordance with the UE not being configured to determine whether the DCI has the first DCI format or the second DCI format, the UE may misinterpret a resource allocation indicated in the DCI, thereby resulting in the UE attempting to receive or transmit data on incorrect frequency resources. Additionally, the UE may incorrectly process a TB-to-CC mapping included in the DCI, thereby resulting in failed data receptions or transmissions. Further, the wireless communications between the UE and the network node may experience higher block error rates resulting from improper decoding attempts by the UE. Even further, in accordance with the UE attempting to decode the DCI separately for both DCI formats, the UE may expend unnecessary processing resources or energy resources of the UE. Moreover, wireless communications between the UE and the network node may fail, in accordance with the UE not being configured to determine whether the DCI has the first DCI format or the second DCI format.

Various aspects generally relate to wireless communications. Some aspects more specifically relate to downlink control information signaling for flexible spectrum integration and carrier aggregation configurations. In some aspects, a network node may transmit, and a UE may receive, configuration information that indicates a first DCI format and a second DCI format for DCI. The first DCI format may be configured to indicate only one of FSI or CA. For example, DCI transmitted by the network node having the first DCI format can include FSI data or can include CA data, but cannot include FSI data and CA data. In contrast, the second DCI format may be configured to indicate both FSI and CA. For example, DCI transmitted by the network node having the second DCI format can include FSI data and CA data in a single transmission. The network node may transmit, and the UE may receive, a physical downlink control channel (PDCCH) communication that includes DCI having the first DCI format or DCI having the second DCI format. In one example, the DCI included in the PDCCH communication may have the first DCI format, and one or more fields of the DCI may indicate an FSI configuration of the UE. In another example, the DCI included in the PDCCH may have the second DCI format, and one or more bits included in the DCI may indicate whether the information included in the DCI is FSI data, CA data, or both FSI data and CA data. The UE and the network node may communicate in accordance with the DCI. In some aspects, a transport block included in the DCI may be configured for each CC mapping of a plurality of CC mappings, may be mapped to one or more subbands, and may be mapped to a single cell. In these aspects, the UE may be configured with information that enables the UE to determine a part of each transport block that is mapped to each subband group to retrieve the transport block. In some other aspects, the UE may be configured with DCI that schedules a transport block based on or otherwise associated with transmitting different parts of the transport block in one or more subband groups. In these aspects, the UE may be configured to obtain information regarding one or more parts of the transport block, of a plurality of parts of the transport block that are being scheduled.

Particular aspects of the subject matter described in this disclosure can be implemented to realize one or more of the following potential advantages. In some examples, by enabling communication of the configuration information that indicates whether DCI has the first DCI format or the second DCI format, the described techniques can be used to reduce a likelihood of the UE misinterpreting a resource allocation indicated in the DCI, thereby reducing a likelihood of the UE attempting to receive or transmit data on incorrect frequency resources. In some examples, by enabling communication of the configuration information that indicates whether the DCI has the first DCI format or the second DCI format, the described techniques can be used to reduce a likelihood of the UE incorrectly processing a TB-to-CC mapping included in the DCI, thereby reducing a likelihood of failed data receptions or transmissions. In some examples, by enabling communication of the configuration information that indicates whether the DCI has the first DCI format or the second DCI format, the described techniques can be used to reduce block error rates in wireless communications resulting from improper decoding attempts by the UE. In some examples, by enabling communication of the configuration information that indicates whether the DCI has the first DCI format or the second DCI format, the described techniques can be used to reduce processing resource usage or energy resource usage by the UE. In some examples, by enabling communication of the configuration information that indicates whether the DCI has the first DCI format or the second DCI format, the described techniques can be used to reduce a likelihood of failed communications between the UE and the network node. These example advantages, among others, are described in more detail below.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

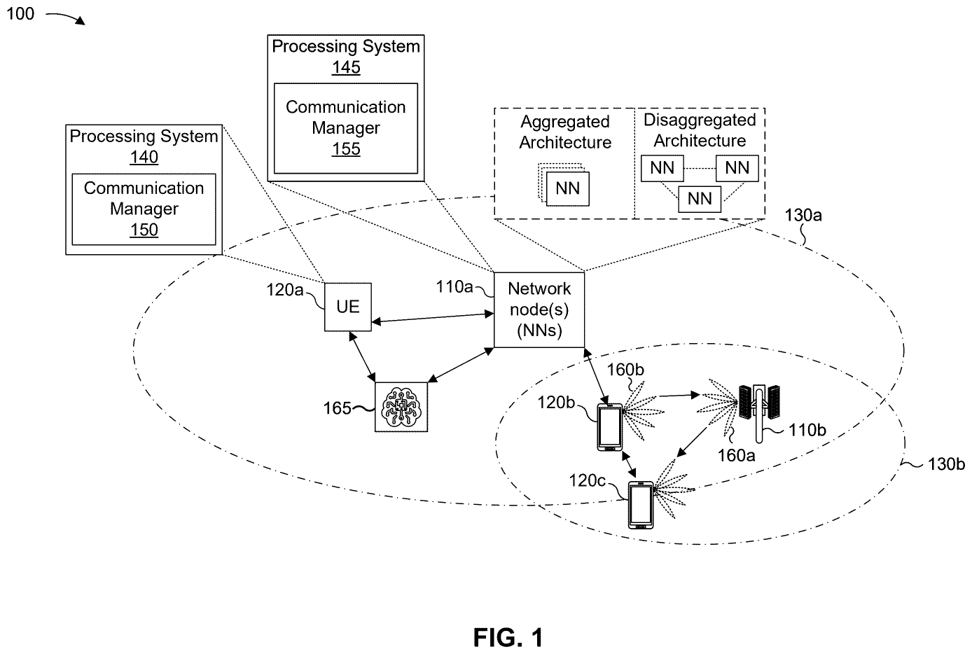

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive configuration information that indicates a first DCI format and a second DCI format, wherein the first DCI format is configured to indicate only one of FSI or CA and the second DCI format is configured to indicate both FSI and CA; receive a PDCCH communication that includes DCI having the first DCI format or DCI having the second DCI format; and communicate with a network node in accordance with the DCI. Additionally, or alternatively, the communication manager 150 may perform one or more other operations described herein.

In some aspects, the network node 110 may include a communication manager 155. As described in more detail elsewhere herein, the communication manager 155 may transmit configuration information that indicates a first DCI format and a second DCI format, wherein the first DCI format is configured to indicate only one of FSI or CA and the second DCI format is configured to indicate both FSI and CA; transmit a PDCCH communication that includes DCI having the first DCI format or DCI having the second DCI format; and communicate with a UE in accordance with the DCI. Additionally, or alternatively, the communication manager 155 may perform one or more other operations described herein.

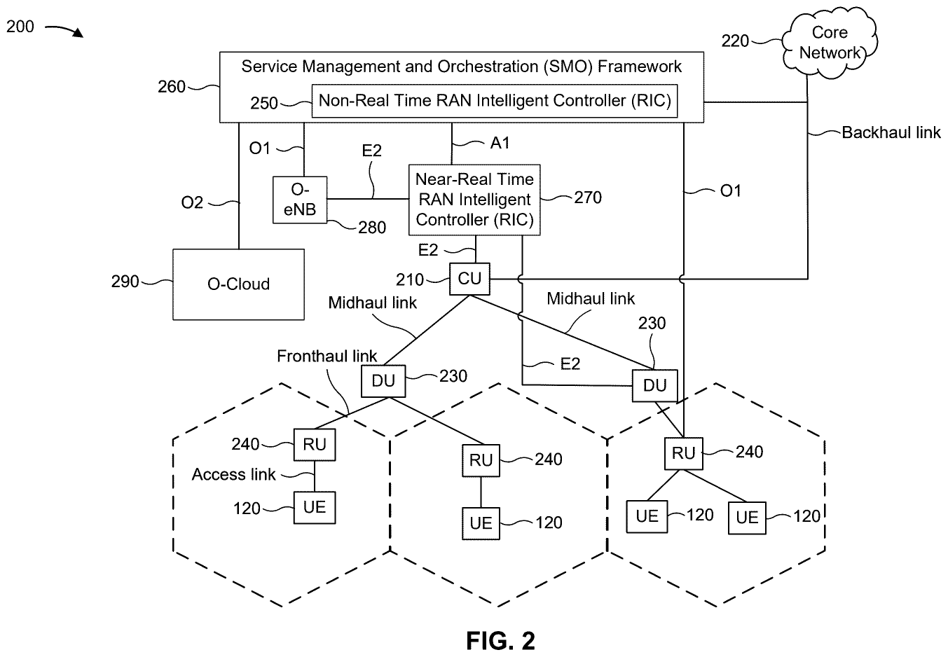

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

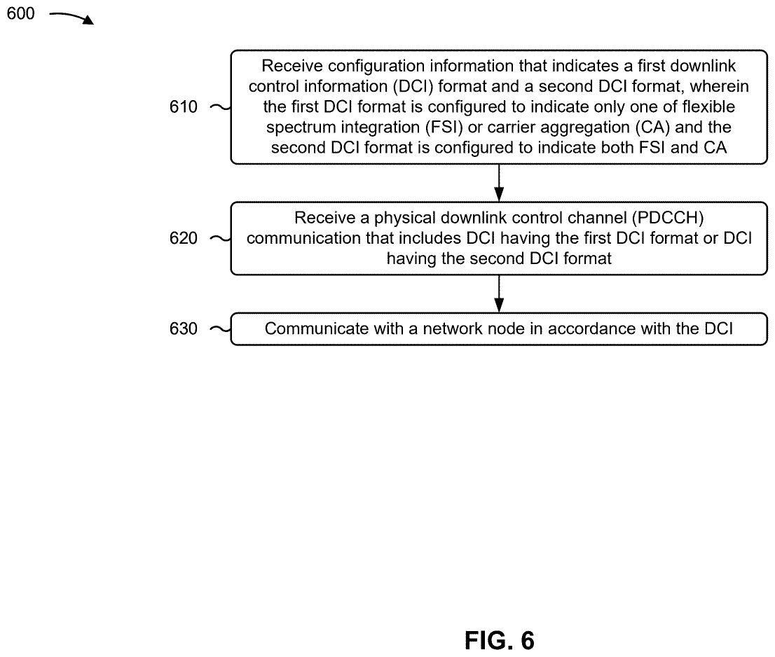

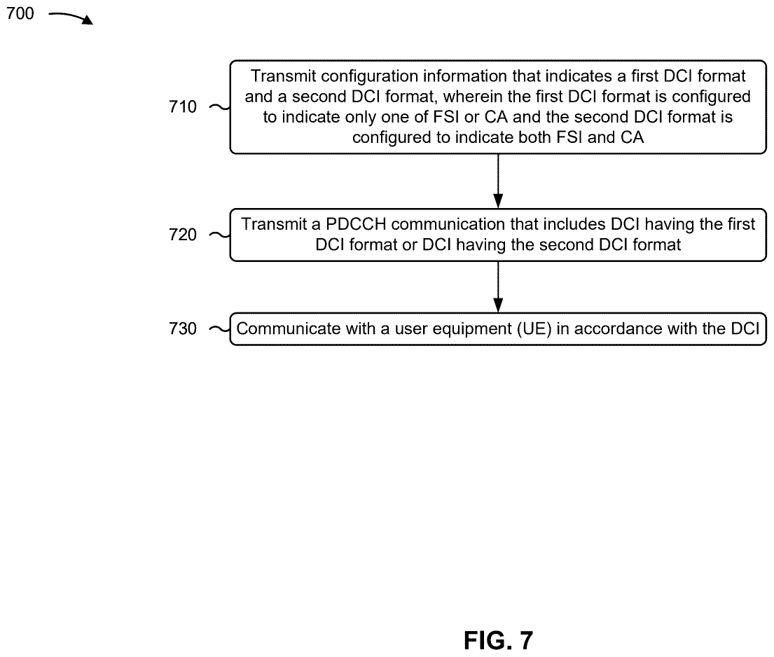

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with downlink control information signaling for flexible spectrum integration and carrier aggregation configurations, as described in more detail elsewhere herein. For example, the processing system 145 of the network node 110, the processing system 140 of the UE 120, the CU 210, the DU 230, or the RU 240 may perform or direct operations of, for example, method 600 of FIG. 6, method 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform method 600 of FIG. 6, method 700 of FIG. 7, or other processes as described herein. In some examples, executing instructions may include running the instructions, converting the instructions, compiling the instructions, or interpreting the instructions, among other examples.

In some aspects, the UE 120 includes means for receiving configuration information that indicates a first DCI format and a second DCI format, wherein the first DCI format is configured to indicate only one of FSI or CA and the second DCI format is configured to indicate both FSI and CA; means for receiving a PDCCH communication that includes DCI having the first DCI format or DCI having the second DCI format; or means for communicating with a network node in accordance with the DCI. The means for UE 120 to perform operations described herein may include, for example, one or more of communication manager 150, processing system 140, a radio, one or more RF chains, one or more transceivers, one or more antennas, one or more modems, a reception component, or a transmission component, among other examples.

In some aspects, the network node 110 includes means for transmitting configuration information that indicates a first DCI format and a second DCI format, wherein the first DCI format is configured to indicate only one of FSI or CA and the second DCI format is configured to indicate both FSI and CA; means for transmitting a PDCCH communication that includes DCI having the first DCI format or DCI having the second DCI format; or means for communicating with a UE in accordance with the DCI. The means for the network node 110 to perform operations described herein may include, for example, one or more of communication manager 155, processing system 145, a radio, one or more RF chains, one or more transceivers, one or more antennas, one or more modems, a reception component, or a transmission component, among other examples.

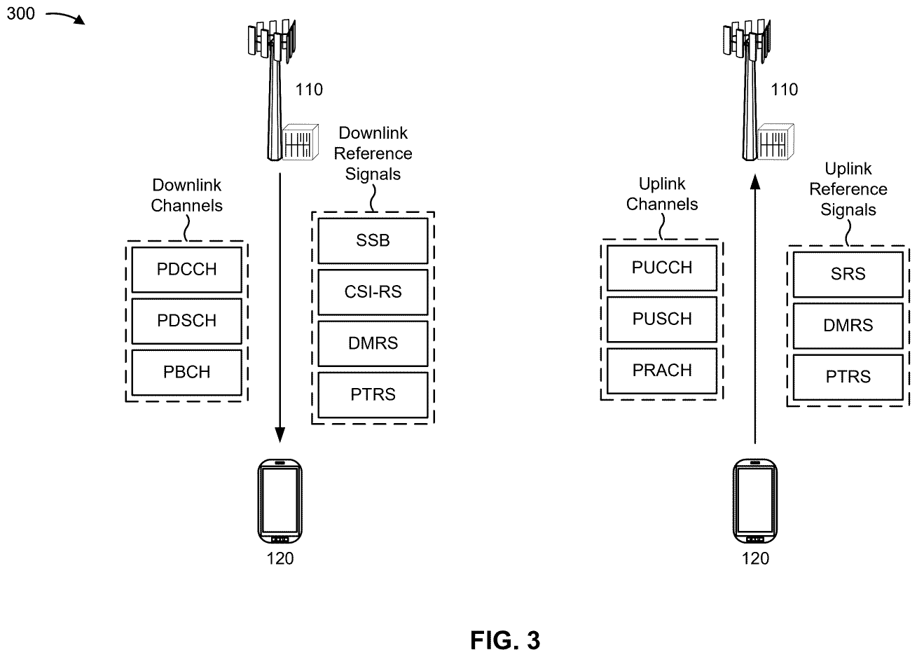

FIG. 3 is a diagram illustrating an example 300 of physical channels and reference signals in a wireless network. As shown in FIG. 3, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

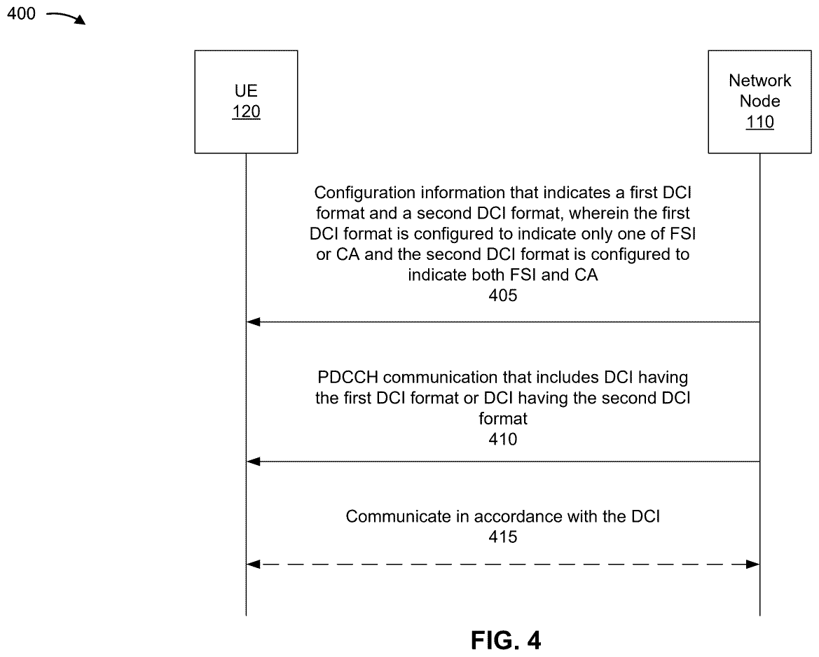

FIG. 4 is a diagram illustrating an example 400 of downlink control information signaling for flexible spectrum integration and carrier aggregation configurations.

As shown by reference number 405, the network node 110 may transmit, and the UE 120 may receive, configuration information that indicates a first DCI format and a second DCI format. The first DCI format may be configured to indicate only one of FSI or CA. For example, in a first option (which may be referred to herein as Option 1), DCI having the first DCI format may include an FSI indication or may include a CA indication, but may not include both the FSI indication and the CA indication. The second DCI format may be configured to indicate both FSI and CA. For example, in a second option (which may be referred to herein as Option 2), DCI having the second DCI format may include an FSI indication, a CA indication, or both an FSI indication and a CA indication. In some aspects, the first DCI format may indicate only FSI and a third DCI may indicate CA. In these aspects, the configuration information may indicate the first DCI format, the second DCI format, and the third DCI format. The UE 120 may be configured to determine whether DCI has the first DCI format, the second DCI format, or the third DCI format in accordance with one or more parameters.

As shown by reference number 410, the network node 110 may transmit, and the UE 120 may receive, a PDCCH communication that includes DCI having the first DCI format or that includes DCI having the second DCI format.

As shown by reference number 415, the UE 120 and the network node 110 may communicate in accordance with the DCI. For example, the UE 120 and the network node 110 may perform an uplink communication or a downlink communication using FSI or CA based at least in part on whether the DCI has the first DCI format or the second DCI format or based at least in part on one or more indicators included in the DCI having the first DCI format or the second DCI format. Additional details are described below.

In some aspects, the PDCCH communication that includes the DCI having the first DCI format may include one or more fields (e.g., one or more bits) that indicate an FSI configuration for the UE 120. The one or more fields may include a frequency domain resource allocation (FDRA) field, a modulation and coding scheme (MCS) field, a time domain resource allocation (TDRA) field, a scheduled cell set and scheduled cell indicator field, a redundancy version (RV) index field, a new data indicator (NDI) field, or a hybrid automatic repeat request (HARQ) process number (HPN) field, among other examples.

In some aspects, the FDRA field for FSI may include one or more blocks of bits, where each block of bits of the one or more blocks of bits indicates a frequency assignment for a particular subband (SB) in the set of SBs configured for the UE 120. In some aspects, the MCS field for FSI may indicate one or more entries in one or more MCS tables. The MCS tables for FSI may be different from the MCS tables for CA since, although the code rate may be constant across SBs, the modulation scheme may change across SBs and, consequently, more than one MCS per-virtual-cell may be signaled. In some aspects, the same TDRA table entries used for CA may be used for FSI. The network node 110 may not schedule a PUSCH communication or a PDSCH communication with CA and FSI using the same time and frequency resources for the same UE 120. Additionally, or alternatively, one or more dedicated TDRA table entries may be used (for example, tables with the same start and length indicator values (and different K_0, K_2 values) for CA and FSI). In some aspects, the scheduled cell set and scheduled cells indicator field for FSI can indicate both the SB set and the combination of SBs within a set that may be used by the UE 120 for PUSCH transmission or PDSCH reception. In one example, similar to a scheduled cell combination list indicator (scheduledCellComboList-DCI-X-3) functionality, if more than one SB combination is configured through RRC, the FDRA may comprise a number of blocks corresponding to the combination of SB groups configured in a scheduledSBGroupComboList-DCI-X-3 information element (IE). If the scheduledSBGroupComboList-DCI-X-3 information element is not configured, the FDRA may include one or more blocks set to 0, which may indicate that the corresponding SB is not scheduled. In some aspects, the RV index field for FSI may indicate a single RV index per TB. This is in contrast to CA where multiple RV indexes may be indicated, such as one or more RV indexes per CC. In some aspects, the NDI field may be signaled per TB in FSI, with as many NDI blocks as the number of TBs being scheduled, regardless of the number of SB groups for mapping each TB. In some aspects, for the HPN field for FSI, a HARQ entity may be configured across some or all of the SB groups in a virtual cell, such that the HPN may be signaled per SB group or per set of SB groups within a virtual cell.

In some aspects, the PDCCH communication may include the DCI having the second DCI format. In these aspects (e.g., for Option 2), there are several possibilities for signaling FSI and CA. Regardless of how the configurations of FSI and CA are configured, the UE 120 may need to be able to differentiate between FSI and CA if both are configured. In some examples, the differentiation procedure may include a one-bit DCI field (FSI/CA), different parameters for the configuration of search spaces or control resource sets (CORESETs) in FSI and CA, or different radio network temporary identifiers (RNTIs) for PDCCH control resource set (CRC) scrambling for FSI and CA, among other examples.

In some aspects, the UE 120 may be configured with FSI (or CA) initially, but may switch to CA (or FSI) based at least in part on signaling from the network node 110. Regardless of how the switching is performed (e.g., using DCI, an RRC message, or a MAC-CE, among other examples), the network node 110 may determine to use FSI for different sets of MCSs and may determine to use CA in other cases. Therefore, the differentiation between FSI and CA may be performed based at least in part on the signaled MCS or the configured MCS table. Additionally, or alternatively, the network node 110 may use FSI for specific applications (which, at the PHY layer, may be differentiated based on PHY-layer priority index) so that, for instance, for URLLC services with stringent reliability requirements, a higher gain may be obtained.

In some aspects, the different DCI parameters to configure the PDSCH communications or the PUSCH communications using FSI or CA may be in accordance with the scheduled cell set and scheduled cells indicator. In a first example (which may be referred to as Option 2, Sub-Option 1), the cell indexes may be configured first, and the SB group indexes may be configured second. For example, the UE 120 may be configured with an MC-DCI-SetofCells information element, but the entries in scheduledCellListDCI-X-3 may be used to signal a set of serving cell indexes and subband group indexes (e.g., {ServCellIndex, SBGroupIndex 0, . . , SBGroupIndex G_c-1}) to indicate which SB groups from the corresponding cell may be scheduled, where a SB group may comprise a single SB or more than one SB, and the different SB groups may be RRC configured, for example, in the ServingCellConfig information element. Correspondingly, scheduledCellComboListDCI-X-3 may indicate which cell and SB groups within scheduledCellListDCI-X-3 are scheduled. In a second example (which may be referred to as Option 2, Sub-Option 2), the SB group indexes may be configured first, and the cell indexes may be configured second. For example, the UE 120 may be configured with an MSB-DCI-SetofSBGroups information element (for example, instead of the MC-DCI-SetofCells information element), with different entries indicating lists of schedulable SB groups (scheduledSBGroupListDCI-X-3) and the actual scheduled SB groups combinations (scheduledSBGroupComboListDCI-X-3) for each list of schedulable SB groups, where an SB group may comprise a single SB or more than one SB and each group may be associated with a serving cell.

In the first example described above (Option 2, Sub-Option 1), the cell indexes may be configured first, and the SB group indexes may be configured second. In these examples, there may be different options to indicate which SB groups of the set of SB groups for a serving cell may be scheduled. In some aspects (which may be referred to as Option 2, Sub-Option 1-1), the cell and SB group combinations may be configured using a joint RRC configuration. In this example, several lists of scheduledCellListDCI-X-3 may be configured, with one scheduledCellListDCI-X-3 list within each MC-DCI-SetofCells field or with several lists of scheduledCellListDCI-X-3 within a single MC-DCI-SetofCells field, where each scheduledCellListDCI-X-3 in the list indicates a sequence of both the ServCellIndex and the SB groups that the UE 120 is to be scheduled with if such a serving cell is scheduled from the corresponding scheduledCelllList-DCI-X-3 list using the FDRA field or scheduledCellComboListDCI-X-3. Any other subset of SB groups for such a serving cell may be indicated in another list scheduledCellListDCI-X-3 present in a different MC-DCI-SetofCells field, or in the same MC-DCI-SetofCells field (in which case an additional DCI indication of which scheduledCellListDCI-X-3 is used for scheduling may be needed).

In some aspects (which may be referred to as Option 2, Sub-Option 1-2), the cell combinations may be configured via an RRC configuration and the SB groups per cell may be indicated using DCI. In these aspects, the entry scheduledCellListDCI-X-3 may be configured with a list of cells (without including SB groups), and the SB groups being scheduled for each cell may be indicated in the DCI via a scheduled SB group indicator per cell field, which indicates the SB group indexes that the UE 120 is scheduled with, or via the FDRA field. When scheduled via the FDRA field, the FDRA field may be a full FDRA field indicating which SB groups are scheduled. Alternatively, the FDRA field may comprise a set of blocks, where each block comprises a bit combination indicating which SB group the current block is associated with, concatenated by the actual FDRA assignment for the corresponding SB group.

In some aspects (which may be referred to as Option 2, Sub-Option 1-3), the cell combinations may be configured using an RRC configuration and the SB groups combination per cell may be indicated using a MAC-CE. In these aspects, the UE 120 may be configured with several SB groups for each cell, and a MAC-CE activation command may indicate to the UE 120 that the UE 120 is to be scheduled with a particular subset of the set of SB groups corresponding to the TCI state that was activated by the MAC-CE command.

In the second example described above (Option 2, Sub-Option 2), the SB group indexes may be configured first, and the cell indexes may be configured second. In these aspects, the ServingCellConfig information element (or another information element or signal) may provide the UE 120 with a set of SB group configurations with unique indexes, which may be either semi-statically or dynamically configured (e.g., SB group 1 may comprise SB #0 and SB #1 in a slot, and the network node 110 may reconfigure SB group 1 to comprise only SB #0, and SB #1 may be introduced as part of another SB group). Additionally, or alternatively, a per-cell SB group reconfiguration may be indicated using DCI, an RRC message, or a MAC-CE. The network node 110 may transmit DCI having a “scheduled cell set” field and a “scheduled cells indicator” field, which are to be used as a “scheduled SB group set” and a “scheduled SB groups indicator,” respectively, and may signal corresponding entries within the MSB-DCI-SetofSBGroups information element to indicate which set of SB groups or which individual SB groups (or which cells) are being scheduled.

In some aspects, the UE 120 may determine whether it is being scheduled by FSI or CA in accordance with at least one of an MSB-DCI-SetofSBGroups or an MC-DCI-SetofCells being configured. If both information elements are configured, the UE 120 may determine whether the actual cells being scheduled are implicitly indicated through the FDRA field or the scheduled cells indicator field in the DCI. In a first example, if the FDRA field is used as the signaling mechanism, the UE 120 may determine how many cells and SB groups are included in the MC-DCI-SetofCells and the MSB-DCI-SetofCells information elements to distinguish between CA and FSI. In a second example, if the scheduled cells indicator field is the signaling mechanism, the UE 120 may determine how many cells and SB groups are included in the entries ScheduledCellCombo and ScheduledSBGroupCombo to distinguish between the FSI and the CA.

In some aspects, the DCI parameters for distinguishing between FSI and CA in PDSCH or PUSCH communications may be the RV index field and the MCS field. For the RV index field, the UE 120 may be configured with a single RV index for single-TB scheduling in FSI, or multiple RV indexes for multi-TB scheduling. Alternatively, for CA, there may be a single RV index per-CC and per-TB. In the example of single-TB scheduling, for CA, one RV index is signaled per CC, whereas for FSI, only one RV index is signaled, regardless of the number of SBs being scheduled. In the example of multi-TB scheduling, for CA, one RV index is signaled per-CC and per-TB, whereas for FSI, only one RV index is signaled per-TB. In some aspects, such as for Option 2, Sub-Option 1, one or more indicators may indicate whether the DCI is for FSI or CA. In one example, the DCI may include a flag that indicates whether FSI or CA is to be used. In another example, a specification constraint may indicate that only one of the two configurations can be enabled by the network node 110. In another example, an implicit indication may be indicated via a search space index, a CORESET index, or an RNTI for the scrambling of the PDCCH CRC under FSI and CA. In another example, a quantity of DMRS ports used in the PDSCH communication or the PUSCH communication that is signaled in the DCI may be used to obtain the number of layers, which may be used to distinguish between one TB or two TBs. For the MCS index field, the MCS for FSI may be signaled per-SB group and per-TB, in contrast to the MCS being signaled per-TB and per-cell in CA. In some aspects, when the number of cells being scheduled is indicated using the DCI indicator field, a number of MCS blocks in a cell may correspond to the different SB groups belonging to that cell that are being scheduled. Additionally, or alternatively, lookup tables for the MCS configured in an RRC message may reflect that using a particular MCS with FSI may yield different QAM orders per SB, even if the code rate is the same across SBs, and the MCS may be used as a differentiation factor for FSI or CA.

In some aspects, in accordance with each TB associated with FSI being mapped to a set of SBs directly, each SB group may carry at least one part of a single transport block (e.g., in the example of single-TB scheduling). Scheduling a complete transport block may be performed using TB-per-CC mapping. For FSI, a TB may be mapped to a quantity of SBs and to a single cell. Therefore, the UE 120 may need information to determine which part of each TB is mapped to each SB group in order to enable the UE 120 to obtain the complete TB. For scheduling a part of a TB, the TB may be split into P TB parts that have an unequal number of bits, and the DCI format can schedule either part p of the TB (0≤p≤P TB) or multiple parts of the TB on multiple SB groups. In some aspects, a single DCI can schedule multiple TBs in different virtual cells, where different parts of each TB can be mapped to one or multiple SB groups in different carriers.

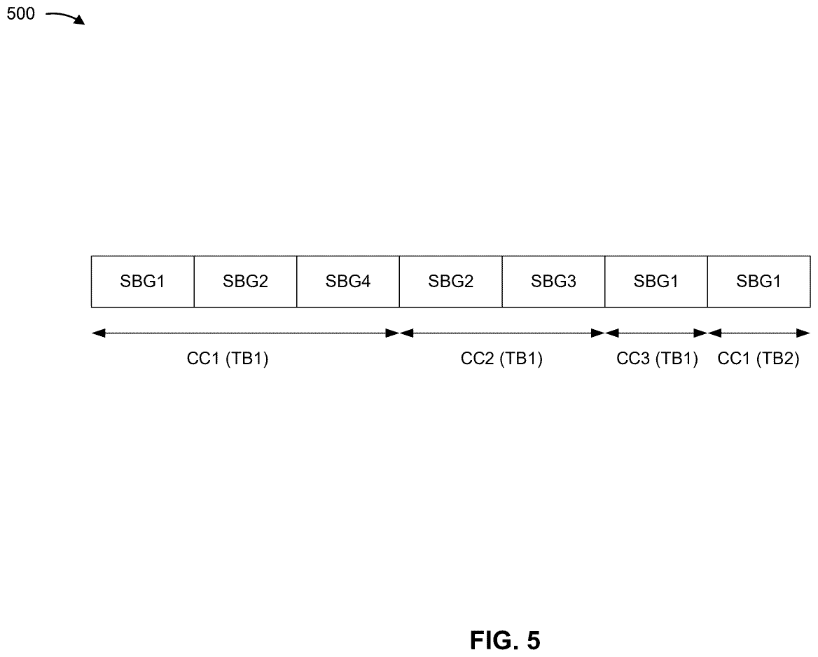

In some aspects, the UE 120 being scheduled with DCI that schedules a TB by transmitting different parts of such TB in one or more SB groups may obtain information about which parts of a TB are being scheduled. In some aspects, an allocation of coded (and potentially interleaved) modulated data tones to SBs may be performed using a frequency first, time second design, in which case the UE 120 is configured to determine how to retrieve the full TB by sorting the TB parts in accordance with the lowest RB index and absolute frequency location of each SB and then by PDSCH reception start time. In some other aspects, such as for more flexible accommodation of TB parts in different SBs and to obtain additional time or frequency diversity, a TB part indicator index field containing the TB part indicators may be included in the DCI. This field in the DCI may include a number of blocks corresponding to the multiple SB groups or TBs, with each block indicating the TB part index transmitted for the corresponding TB on the corresponding SB group and cell, and the different blocks may be arranged in ascending order of SB group index first, cell index second, TB index third, or any permutation or combination of these indexes. Similar examples may apply for multiple parts of TBs being scheduled on one or more component carriers using FSI. Additional details regarding these features are described in connection with FIG. 5.

As indicated above, FIG. 4 is provided as an example. Other examples may differ from what is described with regard to FIG. 4.

FIG. 5 is a diagram illustrating an example 500 of transport block to subband group mapping for flexible spectrum integration. In some aspects, three component carriers may be configured for an FSI configuration. A first component carrier (CC1) may have four SB groups in a ServingCellConfig information element, a second component carrier (CC2) may have three SB groups in the ServingCellConfig information element, and a third component carrier (CC3) may have two SB groups in a ServingCellConfig information element. A DCI having a DCI format may schedule a PDSCH communication or a PUSCH communication using FSI with a cell and SB group configuration where CC1 is associated with SB group 1 (SBG1), SB group 2 (SBG2), and SB group 4 (SBG4), CC2 is associated with SBG2 and SB group 3 (SBG3), and CC3 is associated with SBG1. Additionally, CC1, CC2, and a first part of CC3 may be associated with a first TB (TB1), whereas a second part of CC3 may be associated with a second TB (TB2). For 2 TBs being scheduled, either the same part index may be transmitted for each TB in each SB group, or different part indexes may be used for each TB.

As indicated above, FIG. 5 is provided as an example. Other examples may differ from what is described with regard to FIG. 5.

FIG. 6 is a flowchart of an example method 600 of wireless communication. The method 600 may be performed at, for example, a UE (e.g., UE 120) or an apparatus of a UE.

Method 600 begins at 610 with receiving configuration information that indicates a first DCI format and a second DCI format, wherein the first DCI format is configured to indicate only one of FSI or CA and the second DCI format is configured to indicate both FSI and CA. For example, the UE may receive configuration information that indicates a first DCI format and a second DCI format, wherein the first DCI format is configured to indicate only one of FSI or CA and the second DCI format is configured to indicate both FSI and CA, as described above in connection with, for example, FIG. 4 and at 405.

Method 600 then proceeds at 620 with receiving a PDCCH communication that includes DCI having the first DCI format or DCI having the second DCI format. For example, the UE may receive a PDCCH communication that includes DCI having the first DCI format or DCI having the second DCI format, as described above in connection with, for example, FIG. 4 and at 410.

Method 600 then proceeds at 630 with communicating with a network node in accordance with the DCI. For example, the UE may communicate with a network node in accordance with the DCI, as described above in connection with, for example, FIG. 4 and at 415.

In some aspects, the configuration information indicates that the DCI has the first DCI format, and one or more fields of the DCI indicate an FSI configuration of the UE.

In some aspects, the one or more fields of the DCI that indicate the FSI configuration of the UE include at least one of an FDRA field, an MCS field, a TDRA field, a scheduled cell set and scheduled cell indicator field, an RV index field, an NDI field, or an HPN field.

In some aspects, the FDRA field indicates that an FDRA includes one or more blocks of bits, each block of bits of the one or more blocks of bits indicating a frequency assignment for a subband of a plurality of subbands configured at the UE, the MCS field indicates one or more entries in one or more MCS tables for FSI, the TDRA field indicates one or more entries in one or more TDRA tables, the scheduled cell set and scheduled cell indicator field indicates a subband set and a combination of subbands within the subband set that are configured for physical uplink shared channel communications or physical downlink shared channel communications, the RV index field indicates a single RV index for each transport block associated with FSI, the NDI field is signaled for each transport block of a plurality of transport blocks, and the HPN field is signaled for each subband group of a plurality of subband groups or is signaled for each set of subband groups of a plurality of sets of subband groups within a virtual cell.

In some aspects, based at least in part on two or more subband combinations being indicated in a radio resource control message, the FDRA field indicates one or more blocks corresponding to a combination of subband groups configured in a scheduled subband group combination list indicator.

In some aspects, based at least in part on a scheduled subband group combination list indicator not being indicated, the FDRA field includes at least one block having a value indicating that a corresponding subband is not scheduled.

In some aspects, the configuration information indicates that the DCI has the second DCI format.

In some aspects, the DCI includes one or more bits that indicate whether the DCI is for FSI or CA.

In some aspects, the configuration information indicates one or more parameters for a configuration of a search space or a control resource set for FSI and CA, or the configuration information indicates one or more radio network temporary identifiers for a PDCCH cyclic redundancy check scrambling for FSI and CA.

In some aspects, the UE is configured with one or more cell indexes and one or more subband group indexes associated with a scheduled cell set indicator and a scheduled cell indicator, wherein the one or more cell indexes are configured before the one or more subband group indexes are configured.

In some aspects, the UE is further configured with an information element that signals a set of serving cell indexes and subband group indexes and that indicates one or more subband groups from which a corresponding cell is to be scheduled, wherein different subband groups of the one or more subband groups are configured using a radio resource control message associated with another information element.

In some aspects, one or more combinations of the one or more cell indexes and the one or more subband group indexes are configured using a joint radio resource control configuration, wherein the one or more combinations of the one or more cell indexes includes a combination of one or more subbands or blocks per cell index.

In some aspects, one or more combinations of the one or more cell indexes are configured using a radio resource control configuration and the one or more subband group indexes are configured using a DCI indicator.

In some aspects, one or more combinations of the one or more cell indexes are configured using a radio resource control configuration and the one or more subband group indexes are configured using a medium access control message.

In some aspects, the UE is configured with one or more subband group indexes and one or more cell indexes associated with a scheduled cell set indicator and a scheduled cell indicator, wherein the one or more subband group indexes are configured prior to the one or more cell indexes.

In some aspects, the UE is further configured with an information element that includes one or more entries indicating one or more combinations of one or more lists of subband groups that are configured to be scheduled and one or more subband groups that are scheduled.

In some aspects, a scheduled cell set DCI field and a scheduled cell indicator DCI field are configured as a scheduled subband group set indicator and a scheduled subband group indicator field, respectively, in the DCI, wherein the scheduled cell set DCI field and the scheduled cell indicator DCI field indicate corresponding entries within an information element and indicate a set of subband groups of a plurality of subband groups that are to be scheduled, wherein each subband group is associated with a cell of a plurality of virtual cells configured at the UE.

In some aspects, the UE is configured to determine whether the UE is being scheduled by FSI or CA based at least in part on whether the UE is configured with a DCI indicator that indicates a set of subband groups or with a DCI indicator that indicates a set of cells.

In some aspects, the UE is configured with both the DCI indicator that indicates the set of subband groups and the DCI indicator that indicates the set of cells, and the UE is configured to determine whether one or more cells being scheduled are indicated in a frequency domain resource allocation field or in a scheduled cell indicator field of the DCI.

In some aspects, the UE is configured with one or more DCI parameters for configuring a PDSCH communication or a PUSCH communication with FSI or CA, wherein the one or more DCI parameters include at least one of an RV index indicator or an MCS indicator.

In some aspects, based at least in part on the DCI including FSI, the UE is configured with a single RV index for single-transport-block scheduling or is configured with multiple RV indexes for multiple-transport-block scheduling.

In some aspects, based at least in part on the DCI including CA, the UE is configured with a single RV index for each component carrier of a plurality of component carriers and for each transport block of a plurality of transport blocks.

In some aspects, one or more blocks of RV indexes are signaled to the UE, and the configuration information includes one or more rules that indicate whether the PDSCH communication or the PUSCH communication is scheduled with FSI or CA.

In some aspects, the DCI includes a flag that indicates whether the PDSCH communication or the PUSCH communication is configured with FSI or CA, wherein the UE is configured with information indicating that only one of the first DCI format or the second DCI format is enabled, wherein the UE is configured with an implicit indication using a search space index, a control resource set index, or a plurality of radio network temporary identifiers for a scrambling of a PDCCH cyclic redundancy check for FSI and CA, or wherein a quantity of demodulation reference signal ports included in the PDSCH communication or the PUSCH communication is configured to be used by the UE to obtain a quantity of layers.

In some aspects, a transport block is configured per component carrier mapping of a plurality of component carrier mappings, wherein the transport block is mapped to one or more subbands and is mapped to a single virtual cell, and wherein the UE is configured with information that enables the UE to determine a part of each transport block that is mapped to each subband group to retrieve the transport block.

In some aspects, the transport block is split into at least a first transport block part and a second transport block part, and the DCI schedules at least one of the first transport block part or the second transport block part for multiple subband groups.

In some aspects, a single DCI schedules a plurality of transport blocks in different virtual cells, and different parts of each transport block are configured to be mapped to a single subband group or to multiple subband groups in different component carriers that belong to a virtual cell of a set of different virtual cells.

In some aspects, the UE is configured with DCI that schedules a transport block based at least in part on transmitting different parts of the transport block in one or more subband groups, and the UE is configured to obtain information regarding one or more parts of the transport block of a plurality of parts of the transport block that are being scheduled.

In some aspects, one or more coded modulated data tones are allocated to one or more subbands using a frequency-first and time-second configuration, and the UE is configured to retrieve an entirety of the transport block by sorting a plurality of transport block parts in accordance with a lowest resource block index or an absolute frequency location of each subband and in accordance with a physical downlink shared channel reception start time.

In some aspects, method 600 includes receiving a transport block part indicator field that includes one or more transport block part indicators.

In some aspects, the transport block part indicator field indicates one or more blocks corresponding to a plurality of subband groups or to a plurality of transport blocks within each block, and different transport blocks within each block are arranged in ascending order using a subband group index, a cell index, and a transport block index.

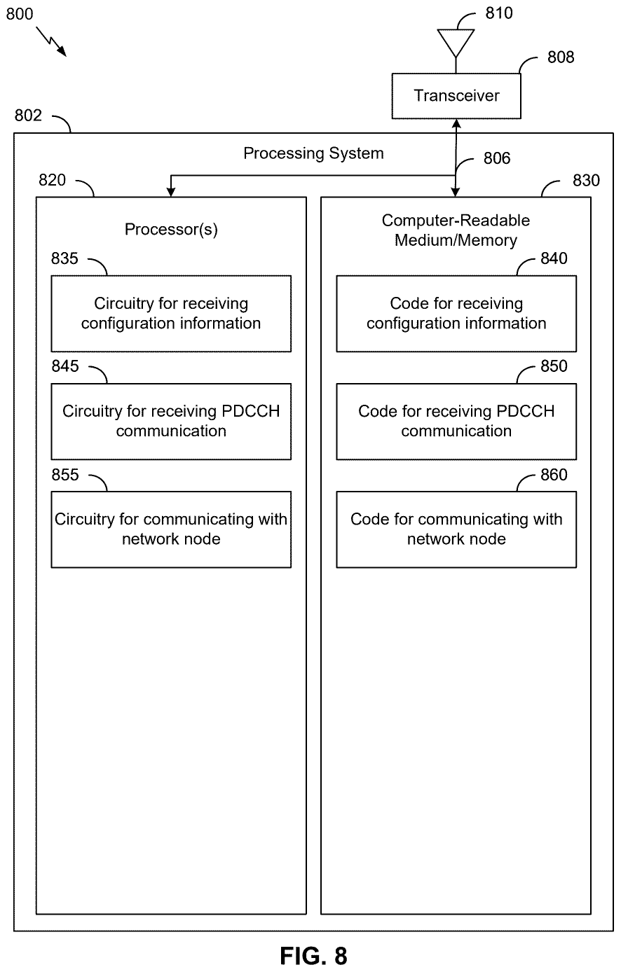

In one aspect, method 600, or any aspect related to it, may be performed by an apparatus, such as communications device 800 of FIG. 8, which includes various components operable, configured, or adapted to perform the method 600. Communications device 800 is described below in further detail.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a flowchart of an example method 700 of wireless communication. The method 700 may be performed at, for example, a network node (e.g., network node 110) or an apparatus of a network node.

Method 700 begins at 710 with transmitting configuration information that indicates a first DCI format and a second DCI format, wherein the first DCI format is configured to indicate only one of FSI or CA and the second DCI format is configured to indicate both FSI and CA. For example, the network node may transmit configuration information that indicates a first DCI format and a second DCI format, wherein the first DCI format is configured to indicate only one of FSI or CA and the second DCI format is configured to indicate both FSI and CA, as described above in connection with, for example, FIG. 4 and at 405.

Method 700 then proceeds at 720 with transmitting a PDCCH communication that includes DCI having the first DCI format or DCI having the second DCI format. For example, the network node may transmit a PDCCH communication that includes DCI having the first DCI format or DCI having the second DCI format, as described above in connection with, for example, FIG. 4 and at 410.

Method 700 then proceeds at 730 with communicating with a UE in accordance with the DCI. For example, the network node may communicate with a UE in accordance with the DCI, as described above in connection with, for example, FIG. 4 and at 415.

In some aspects, the configuration information indicates that the DCI has the first DCI format, and one or more fields of the DCI indicate an FSI configuration of the UE.

In some aspects, the one or more fields of the DCI that indicate the FSI configuration of the UE include at least one of an FDRA field, an MCS field, a TDRA field, a scheduled cell set and scheduled cell indicator field, an RV index field, an NDI field, or an HPN field.

In some aspects, the FDRA field indicates that an FDRA includes one or more blocks of bits, each block of bits of the one or more blocks of bits indicating a frequency assignment for a subband of a plurality of subbands configured at the UE, the MCS field indicates one or more entries in one or more MCS tables for FSI, the TDRA field indicates one or more entries in one or more TDRA tables, the scheduled cell set and scheduled cell indicator field indicates a subband set and a combination of subbands within the subband set that are configured for physical uplink shared channel communications or physical downlink shared channel communications, the RV index field indicates a single RV index for each transport block associated with FSI, the NDI field is signaled for each transport block of a plurality of transport blocks, and the HPN field is signaled for each subband group of a plurality of subband groups or is signaled for each set of subband groups of a plurality of sets of subband groups within a virtual cell.

In some aspects, based at least in part on two or more subband combinations being indicated in a radio resource control message, the FDRA field indicates one or more blocks corresponding to a combination of subband groups configured in a scheduled subband group combination list indicator.

In some aspects, based at least in part on a scheduled subband group combination list indicator not being indicated, the FDRA field includes at least one block having a value indicating that a corresponding subband is not scheduled.

In some aspects, the configuration information indicates that the DCI has the second DCI format.

In some aspects, the DCI includes one or more bits that indicate whether the DCI is for FSI or CA.

In some aspects, the configuration information indicates one or more parameters for a configuration of a search space or a control resource set for FSI and CA, or the configuration information indicates one or more radio network temporary identifiers for a PDCCH cyclic redundancy check scrambling for FSI and CA.

In some aspects, method 700 includes configuring the UE with one or more cell indexes and one or more subband group indexes associated with a scheduled cell set indicator and a scheduled cell indicator, wherein the one or more cell indexes are configured before the one or more subband group indexes are configured.

In some aspects, method 700 includes configuring the UE with an information element that signals a set of serving cell indexes and subband group indexes and that indicates one or more subband groups from which a corresponding cell is to be scheduled, wherein different subband groups of the one or more subband groups are configured using a radio resource control message associated with another information element.

In some aspects, one or more combinations of the one or more cell indexes and the one or more subband group indexes are configured using a joint radio resource control configuration, wherein the one or more combinations of the one or more cell indexes includes a combination of one or more subbands or blocks per cell index.

In some aspects, one or more combinations of the one or more cell indexes are configured using a radio resource control configuration and the one or more subband group indexes are configured using a DCI indicator.

In some aspects, one or more combinations of the one or more cell indexes are configured using a radio resource control configuration and the one or more subband group indexes are configured using a medium access control message.

In some aspects, method 700 includes configuring the UE with one or more subband group indexes and one or more cell indexes associated with a scheduled cell set indicator and a scheduled cell indicator, wherein the one or more subband group indexes are configured prior to the one or more cell indexes.

In some aspects, method 700 includes configuring the UE with an information element that includes one or more entries indicating one or more combinations of one or more lists of subband groups that are configured to be scheduled and one or more subband groups that are scheduled.

In some aspects, a scheduled cell set DCI field and a scheduled cell indicator DCI field are configured as a scheduled subband group set indicator and a scheduled subband group indicator field, respectively, in the DCI, wherein the scheduled cell set DCI field and the scheduled cell indicator DCI field indicate corresponding entries within an information element and indicate a set of subband groups of a plurality of subband groups that are to be scheduled, wherein each subband group is associated with a cell of a plurality of virtual cells configured at the UE.

In some aspects, method 700 includes configuring the UE with information that enables the UE to determine whether the UE is being scheduled by FSI or CA based at least in part on whether the UE is configured with a DCI indicator that indicates a set of subband groups or with a DCI indicator that indicates a set of cells.

In some aspects, method 700 includes configuring the UE with information that enables the UE to determine whether one or more cells being scheduled are indicated in a frequency domain resource allocation field or in a scheduled cell indicator field of the DCI.

In some aspects, method 700 includes configuring the UE with one or more DCI parameters for configuring a PDSCH communication or a PUSCH communication with FSI or CA, wherein the one or more DCI parameters include at least one of a RV index indicator or a MCS indicator.

In some aspects, based at least in part on the DCI including FSI, configuring the UE with a single RV index for single-transport-block scheduling or is configured with multiple RV indexes for multiple-transport-block scheduling.

In some aspects, based at least in part on the DCI including CA, configuring the UE with a single RV index for each component carrier of a plurality of component carriers and for each transport block of a plurality of transport blocks.

In some aspects, one or more blocks of RV indexes are signaled to the UE, and the configuration information includes one or more rules that indicate whether the PDSCH communication or the PUSCH communication is scheduled with FSI or CA.

In some aspects, the DCI includes a flag that indicates whether the PDSCH communication or the PUSCH communication is configured with FSI or CA, wherein the UE is configured with information indicating that only one of the first DCI format or the second DCI format is enabled, wherein the UE is configured with an implicit indication using a search space index, a control resource set index, or a plurality of radio network temporary identifiers for a scrambling of a PDCCH cyclic redundancy check for FSI and CA, or wherein a quantity of demodulation reference signal ports included in the PDSCH communication or the PUSCH communication is configured to be used by the UE to obtain a quantity of layers.

In some aspects, a transport block is configured per component carrier mapping of a plurality of component carrier mappings, wherein the transport block is mapped to one or more subbands and is mapped to a single virtual cell, and the UE is configured with information that enables the UE to determine a part of each transport block that is mapped to each subband group to retrieve the transport block.

In some aspects, the transport block is split into at least a first transport block part and a second transport block part, and the DCI schedules at least one of the first transport block part or the second transport block part for multiple subband groups.

In some aspects, a single DCI schedules a plurality of transport blocks in different virtual cells, and different parts of each transport block are configured to be mapped to a single subband group or to multiple subband groups in different component carriers that belong to a virtual cell of a set of different virtual cells.

In some aspects, method 700 includes configuring the UE with DCI that schedules a transport block based at least in part on transmitting different parts of the transport block in one or more subband groups, and the UE is configured to obtain information regarding one or more parts of the transport block of a plurality of parts of the transport block that are being scheduled.

In some aspects, one or more coded modulated data tones are allocated to one or more subbands using a frequency-first and time-second configuration, and the UE is configured to retrieve an entirety of the transport block by sorting a plurality of transport block parts in accordance with a lowest resource block index or an absolute frequency location of each subband and in accordance with a physical downlink shared channel reception start time.

In some aspects, method 700 includes transmitting a transport block part indicator field that includes one or more transport block part indicators.

In some aspects, the transport block part indicator field indicates one or more blocks corresponding to a plurality of subband groups or to a plurality of transport blocks within each block, and different transport blocks within each block are arranged in ascending order using a subband group index, a cell index, and a transport block index.

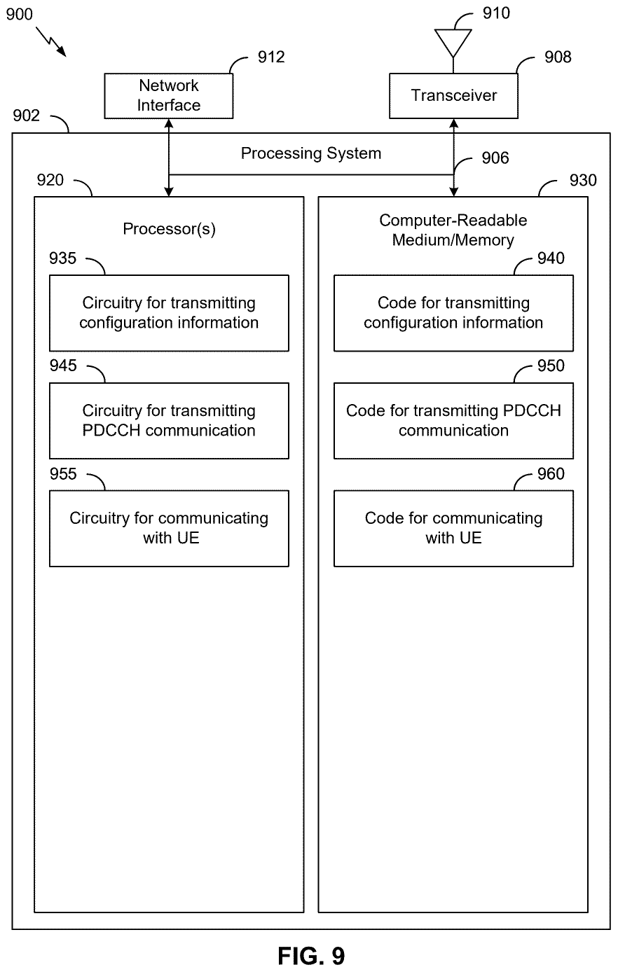

In one aspect, method 700, or any aspect related to it, may be performed by an apparatus, such as communications device 900 of FIG. 9, which includes various components operable, configured, or adapted to perform the method 700. Communications device 900 is described below in further detail.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a diagram illustrating an example of an implementation of code and circuitry for a communications device 800. The communications device 800 may be a UE, or a UE may include the communications device 800.

The communications device 800 includes a processing system 802 coupled to a transceiver 808 (e.g., a transmitter or a receiver, and which may include a single transceivers or multiple transceivers which may perform different operations described as being performed by the transceiver 808). The processing system 802 may be, or may be similar to, the processing system 140 of the UE 120. The transceiver 808 is configured to transmit and receive signals for the communications device 800 via an antenna 810, such as the various signals as described herein. The processing system 802 may be configured to perform processing functions for the communications device 800, including processing signals received or to be transmitted by the communications device 800.

The processing system 802 includes one or more processors 820. In various aspects, the one or more processors 820 may include one or more of a receive processor, a transmit processor, a TX MIMO processor, or a controller/processor, among other examples, such as one or more processors described in connection with the processing system 140 of the UE 120. The one or more processors 820 are coupled to a computer-readable medium/memory 830 via a bus 806. In various aspects, the computer-readable medium/memory 830 may include one or more memories. In certain aspects, the computer-readable medium/memory 830 is configured to store instructions (e.g., computer-executable code, processor-executable code) that when executed by the one or more processors 820, cause the one or more processors 820 to perform the method 600 described with respect to FIG. 6, or any aspect related to it. Note that reference to a processor performing a function of communications device 800 may include one or more processors performing that function of communications device 800. Note also that reference to one or more processors performing multiple functions may include a first processor performing a first function of the multiple functions and a second processor performing a second function of the multiple functions.

As shown in FIG. 8, the communications device 800 may include circuitry for receiving configuration information that indicates a first DCI format and a second DCI format, wherein the first DCI format is configured to indicate only one of FSI or CA and the second DCI format is configured to indicate both FSI and CA (circuitry 835).

As shown in FIG. 8, the communications device 800 may include, stored in computer-readable medium/memory 830, code for receiving configuration information that indicates a first DCI format and a second DCI format, wherein the first DCI format is configured to indicate only one of FSI or CA and the second DCI format is configured to indicate both FSI and CA (code 840).

As shown in FIG. 8, the communications device 800 may include circuitry for receiving a PDCCH communication that includes DCI having the first DCI format or DCI having the second DCI format (circuitry 845).

As shown in FIG. 8, the communications device 800 may include, stored in computer-readable medium/memory 830, code for receiving a PDCCH communication that includes DCI having the first DCI format or DCI having the second DCI format (code 850).

As shown in FIG. 8, the communications device 800 may include circuitry for communicating with a network node in accordance with the DCI (circuitry 855).

As shown in FIG. 8, the communications device 800 may include, stored in computer-readable medium/memory 830, code for communicating with a network node in accordance with the DCI (code 860).

Various components of the communications device 800 may provide means for performing the method 600 described with respect to FIG. 6, or any aspect related to it. For example, means for transmitting, sending, or outputting for transmission may include one or more components of the processing system 140 or the UE 120 (such as transceiver(s) or antenna(s) of the UE 120) or transceiver 808 and antenna 810 of the communications device 800 in FIG. 8. Means for receiving or obtaining may include one or more components of the processing system 140 or the UE 120 (such as transceiver(s) or antenna(s) of the UE 120) or transceiver 808 and antenna 810 of the communications device 800 in FIG. 8.

FIG. 8 is provided as an example. Other examples may differ from what is described in connection with FIG. 8.

FIG. 9 is a diagram illustrating an example of an implementation of code and circuitry for a communications device 900. The communications device 900 may be a network node (such as network node 110 or a disaggregated base station as described with regard to FIG. 2), or a network node may include the communications device 900.

The communications device 900 includes a processing system 902 coupled to a transceiver 908 (e.g., a transmitter or a receiver, and which may include a single transceivers or multiple transceivers which may perform different operations described as being performed by the transceiver 908). The processing system 902 may be, or may be similar to, the processing system 145 of the network node 110. The transceiver 908 is configured to transmit and receive signals for the communications device 900 via an antenna 910 (e.g., one or more antennas), such as the various signals as described herein. The network interface 912 is configured to obtain and send signals for the communications device 900 via communications link(s), such as a backhaul link, midhaul link, or fronthaul link as described herein, such as with respect to FIG. 2. The processing system 902 may be configured to perform processing functions for the communications device 900, including processing signals received or to be transmitted by the communications device 900.

The processing system 902 includes one or more processors 920. In various aspects, the one or more processors 920 may include one or more of a receive processor, a transmit processor, a TX MIMO processor, or a controller/processor, among other examples, such as one or more processors described in connection with the processing system 145 of the network node 110. The one or more processors 920 are coupled to a computer-readable medium/memory 930 via a bus 906. In various aspects, the computer-readable medium/memory 930 may include one or more memories. In certain aspects, the computer-readable medium/memory 930 is configured to store instructions (e.g., computer-executable code, processor-executable code) that when executed by the one or more processors 920, cause the one or more processors 920 to perform the method 700 described with respect to FIG. 7, or any aspect related to it. Note that reference to a processor performing a function of communications device 900 may include one or more processors performing that function of communications device 900. Note also that reference to one or more processors performing multiple functions may include a first processor performing a first function of the multiple functions and a second processor performing a second function of the multiple functions.

As shown in FIG. 9, the communications device 900 may include circuitry for transmitting configuration information that indicates a first DCI format and a second DCI format, wherein the first DCI format is configured to indicate only one of FSI or CA and the second DCI format is configured to indicate both FSI and CA (circuitry 935).

As shown in FIG. 9, the communications device 900 may include, stored in computer-readable medium/memory 930, code for transmitting configuration information that indicates a first DCI format and a second DCI format, wherein the first DCI format is configured to indicate only one of FSI or CA and the second DCI format is configured to indicate both FSI and CA (code 940).

As shown in FIG. 9, the communications device 900 may include circuitry for transmitting a PDCCH communication that includes DCI having the first DCI format or DCI having the second DCI format (circuitry 945).

As shown in FIG. 9, the communications device 900 may include, stored in computer-readable medium/memory 930, code for transmitting a PDCCH communication that includes DCI having the first DCI format or DCI having the second DCI format (code 950).

As shown in FIG. 9, the communications device 900 may include circuitry for communicating with a UE in accordance with the DCI (circuitry 955).

As shown in FIG. 9, the communications device 900 may include, stored in computer-readable medium/memory 930, code for communicating with a UE in accordance with the DCI (code 960).

Various components of the communications device 900 may provide means for performing the method 700 described with respect to FIG. 7, or any aspect related to it. For example, means for transmitting, sending, or outputting for transmission may include one or more components of the processing system 145 or the network node 110 (such as transceiver(s) or antenna(s) of the network node 110) or the transceiver 908 or antenna 910 of the communications device 900 in FIG. 9. Means for receiving or obtaining may include one or more components of the processing system 145 or the network node 110 (such as transceiver(s) or antenna(s) of the network node 110) or the transceiver 908 or antenna 910 of the communications device 900 in FIG. 9.

FIG. 9 is provided as an example. Other examples may differ from what is described in connection with FIG. 9.

The following provides an overview of some Aspects of the present disclosure:

Aspect 1: A method of wireless communication performed by a user equipment (UE), comprising: receiving configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA; receiving a physical downlink control channel (PDCCH) communication that includes DCI having the first DCI format or DCI having the second DCI format; and communicating with a network node in accordance with the DCI.

Aspect 2: The method of Aspect 1, wherein the configuration information indicates that the DCI has the first DCI format, and wherein one or more fields of the DCI indicate an FSI configuration of the UE.

Aspect 3: The method of Aspect 2, wherein the one or more fields of the DCI that indicate the FSI configuration of the UE include at least one of a frequency domain resource allocation (FDRA) field, a modulation and coding scheme (MCS) field, a time domain resource allocation (TDRA) field, a scheduled cell set and scheduled cell indicator field, a redundancy version (RV) index field, a new data indicator (NDI) field, or a hybrid automatic repeat request (HARQ) process number (HPN) field.

Aspect 4: The method of Aspect 3, wherein the FDRA field indicates that an FDRA includes one or more blocks of bits, each block of bits of the one or more blocks of bits indicating a frequency assignment for a subband of a plurality of subbands configured at the UE, wherein the MCS field indicates one or more entries in one or more MCS tables for FSI, wherein the TDRA field indicates one or more entries in one or more TDRA tables, wherein the scheduled cell set and scheduled cell indicator field indicates a subband set and a combination of subbands within the subband set that are configured for physical uplink shared channel communications or physical downlink shared channel communications, wherein the RV index field indicates a single RV index for each transport block associated with FSI, wherein the NDI field is signaled for each transport block of a plurality of transport blocks, and wherein the HPN field is signaled for each subband group of a plurality of subband groups or is signaled for each set of subband groups of a plurality of sets of subband groups within a virtual cell.

Aspect 5: The method of Aspect 4, wherein, based at least in part on two or more subband combinations being indicated in a radio resource control message, the FDRA field indicates one or more blocks corresponding to a combination of subband groups configured in a scheduled subband group combination list indicator.

Aspect 6: The method of Aspect 4, wherein, based at least in part on a scheduled subband group combination list indicator not being indicated, the FDRA field includes at least one block having a value indicating that a corresponding subband is not scheduled.

Aspect 7: The method of any of Aspects 1-6, wherein the configuration information indicates that the DCI has the second DCI format.

Aspect 8: The method of Aspect 7, wherein the DCI includes one or more bits that indicate whether the DCI is for FSI or CA.

Aspect 9: The method of Aspect 7, wherein the configuration information indicates one or more parameters for a configuration of a search space or a control resource set for FSI and CA, or the configuration information indicates one or more radio network temporary identifiers for a physical downlink control channel (PDCCH) cyclic redundancy check scrambling for FSI and CA.

Aspect 10: The method of Aspect 7, wherein the UE is configured with one or more cell indexes and one or more subband group indexes associated with a scheduled cell set indicator and a scheduled cell indicator, wherein the one or more cell indexes are configured before the one or more subband group indexes are configured.

Aspect 11: The method of Aspect 10, wherein the UE is further configured with an information element that signals a set of serving cell indexes and subband group indexes and that indicates one or more subband groups from which a corresponding cell is to be scheduled, wherein different subband groups of the one or more subband groups are configured using a radio resource control message associated with another information element.

Aspect 12: The method of Aspect 10, wherein one or more combinations of the one or more cell indexes and the one or more subband group indexes are configured using a joint radio resource control configuration, wherein the one or more combinations of the one or more cell indexes includes a combination of one or more subbands or blocks per cell index.

Aspect 13: The method of Aspect 10, wherein one or more combinations of the one or more cell indexes are configured using a radio resource control configuration and the one or more subband group indexes are configured using a DCI indicator.

Aspect 14: The method of Aspect 10, wherein one or more combinations of the one or more cell indexes are configured using a radio resource control configuration and the one or more subband group indexes are configured using a medium access control message.

Aspect 15: The method of Aspect 7, wherein the UE is configured with one or more subband group indexes and one or more cell indexes associated with a scheduled cell set indicator and a scheduled cell indicator, wherein the one or more subband group indexes are configured prior to the one or more cell indexes.

Aspect 16: The method of Aspect 15, wherein the UE is further configured with an information element that includes one or more entries indicating one or more combinations of one or more lists of subband groups that are configured to be scheduled and one or more subband groups that are scheduled.

Aspect 17: The method of Aspect 15, wherein a scheduled cell set DCI field and a scheduled cell indicator DCI field are configured as a scheduled subband group set indicator and a scheduled subband group indicator field, respectively, in the DCI, wherein the scheduled cell set DCI field and the scheduled cell indicator DCI field indicate corresponding entries within an information element and indicate a set of subband groups of a plurality of subband groups that are to be scheduled, wherein each subband group is associated with a cell of a plurality of virtual cells configured at the UE.

Aspect 18: The method of Aspect 15, wherein the UE is configured to determine whether the UE is being scheduled by FSI or CA based at least in part on whether the UE is configured with a DCI indicator that indicates a set of subband groups or with a DCI indicator that indicates a set of cells.

Aspect 19: The method of Aspect 18, wherein the UE is configured with both the DCI indicator that indicates the set of subband groups and the DCI indicator that indicates the set of cells, and wherein the UE is configured to determine whether one or more cells being scheduled are indicated in a frequency domain resource allocation field or in a scheduled cell indicator field of the DCI.

Aspect 20: The method of Aspect 15, wherein the UE is configured with one or more DCI parameters for configuring a physical downlink shared channel (PDSCH) communication or a physical uplink shared channel (PUSCH) communication with FSI or CA, wherein the one or more DCI parameters include at least one of a redundancy version (RV) index indicator or a modulation and coding scheme (MCS) indicator.

Aspect 21: The method of Aspect 20, wherein, based at least in part on the DCI including FSI, the UE is configured with a single RV index for single-transport-block scheduling or is configured with multiple RV indexes for multiple-transport-block scheduling.

Aspect 22: The method of Aspect 20 wherein, based at least in part on the DCI including CA, the UE is configured with a single RV index for each component carrier of a plurality of component carriers and for each transport block of a plurality of transport blocks.

Aspect 23: The method of Aspect 20, wherein one or more blocks of redundancy version (RV) indexes are signaled to the UE, and wherein the configuration information includes one or more rules that indicate whether the PDSCH communication or the PUSCH communication is scheduled with FSI or CA.

Aspect 24: The method of Aspect 23, wherein the DCI includes a flag that indicates whether the PDSCH communication or the PUSCH communication is configured with FSI or CA, wherein the UE is configured with information indicating that only one of the first DCI format or the second DCI format is enabled, wherein the UE is configured with an implicit indication using a search space index, a control resource set index, or a plurality of radio network temporary identifiers for a scrambling of a PDCCH cyclic redundancy check for FSI and CA, or wherein a quantity of demodulation reference signal ports included in the PDSCH communication or the PUSCH communication is configured to be used by the UE to obtain a quantity of layers.

Aspect 25: The method of any of Aspects 1-24, wherein a transport block is configured per component carrier mapping of a plurality of component carrier mappings, wherein the transport block is mapped to one or more subbands and is mapped to a single virtual cell, and wherein the UE is configured with information that enables the UE to determine a part of each transport block that is mapped to each subband group to retrieve the transport block.

Aspect 26: The method of Aspect 25, wherein the transport block is split into at least a first transport block part and a second transport block part, and wherein the DCI schedules at least one of the first transport block part or the second transport block part for multiple subband groups.

Aspect 27: The method of Aspect 25, wherein a single DCI schedules a plurality of transport blocks in different virtual cells, and wherein different parts of each transport block are configured to be mapped to a single subband group or to multiple subband groups in different component carriers that belong to a virtual cell of a set of different virtual cells.

Aspect 28: The method of any of Aspects 1-27, wherein a UE is configured with DCI that schedules a transport block based at least in part on transmitting different parts of the transport block in one or more subband groups, and wherein the UE is configured to obtain information regarding one or more parts of the transport block of a plurality of parts of the transport block that are being scheduled.

Aspect 29: The method of Aspect 28, wherein one or more coded modulated data tones are allocated to one or more subbands using a frequency-first and time-second configuration, and wherein the UE is configured to retrieve an entirety of the transport block by sorting a plurality of transport block parts in accordance with a lowest resource block index or an absolute frequency location of each subband and in accordance with a physical downlink shared channel reception start time.

Aspect 30: The method of Aspect 28, further comprising receiving a transport block part indicator field that includes one or more transport block part indicators.

Aspect 31: The method of Aspect 30, wherein the transport block part indicator field indicates one or more blocks corresponding to a plurality of subband groups or to a plurality of transport blocks within each block, and wherein different transport blocks within each block are arranged in ascending order using a subband group index, a cell index, and a transport block index.

Aspect 32: A method of wireless communication performed by a network node, comprising: transmitting configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA; transmitting a physical downlink control channel (PDCCH) communication that includes DCI having the first DCI format or DCI having the second DCI format; and communicating with a user equipment (UE) in accordance with the DCI.

Aspect 33: The method of Aspect 32, wherein the configuration information indicates that the DCI has the first DCI format, and wherein one or more fields of the DCI indicate an FSI configuration of the UE.

Aspect 34: The method of Aspect 33, wherein the one or more fields of the DCI that indicate the FSI configuration of the UE include at least one of a frequency domain resource allocation (FDRA) field, a modulation and coding scheme (MCS) field, a time domain resource allocation (TDRA) field, a scheduled cell set and scheduled cell indicator field, a redundancy version (RV) index field, a new data indicator (NDI) field, or a hybrid automatic repeat request (HARQ) process number (HPN) field.

Aspect 35: The method of Aspect 34, wherein the FDRA field indicates that an FDRA includes one or more blocks of bits, each block of bits of the one or more blocks of bits indicating a frequency assignment for a subband of a plurality of subbands configured at the UE, wherein the MCS field indicates one or more entries in one or more MCS tables for FSI, wherein the TDRA field indicates one or more entries in one or more TDRA tables, wherein the scheduled cell set and scheduled cell indicator field indicates a subband set and a combination of subbands within the subband set that are configured for physical uplink shared channel communications or physical downlink shared channel communications, wherein the RV index field indicates a single RV index for each transport block associated with FSI, wherein the NDI field is signaled for each transport block of a plurality of transport blocks, and wherein the HPN field is signaled for each subband group of a plurality of subband groups or is signaled for each set of subband groups of a plurality of sets of subband groups within a virtual cell.

Aspect 36: The method of Aspect 35, wherein, based at least in part on two or more subband combinations being indicated in a radio resource control message, the FDRA field indicates one or more blocks corresponding to a combination of subband groups configured in a scheduled subband group combination list indicator.

Aspect 37: The method of Aspect 35, wherein, based at least in part on a scheduled subband group combination list indicator not being indicated, the FDRA field includes at least one block having a value indicating that a corresponding subband is not scheduled.

Aspect 38: The method of any of Aspects 32-37, wherein the configuration information indicates that the DCI has the second DCI format.

Aspect 39: The method of Aspect 38, wherein the DCI includes one or more bits that indicate whether the DCI is for FSI or CA.

Aspect 40: The method of Aspect 38, wherein the configuration information indicates one or more parameters for a configuration of a search space or a control resource set for FSI and CA, or the configuration information indicates one or more radio network temporary identifiers for a physical downlink control channel (PDCCH) cyclic redundancy check scrambling for FSI and CA.

Aspect 41: The method of Aspect 38, further comprising configuring the UE with one or more cell indexes and one or more subband group indexes associated with a scheduled cell set indicator and a scheduled cell indicator, wherein the one or more cell indexes are configured before the one or more subband group indexes are configured.

Aspect 42: The method of Aspect 41, further comprising configuring the UE with an information element that signals a set of serving cell indexes and subband group indexes and that indicates one or more subband groups from which a corresponding cell is to be scheduled, wherein different subband groups of the one or more subband groups are configured using a radio resource control message associated with another information element.

Aspect 43: The method of Aspect 41, wherein one or more combinations of the one or more cell indexes and the one or more subband group indexes are configured using a joint radio resource control configuration, wherein the one or more combinations of the one or more cell indexes includes a combination of one or more subbands or blocks per cell index.

Aspect 44: The method of Aspect 41, wherein one or more combinations of the one or more cell indexes are configured using a radio resource control configuration and the one or more subband group indexes are configured using a DCI indicator.

Aspect 45: The method of Aspect 41, wherein one or more combinations of the one or more cell indexes are configured using a radio resource control configuration and the one or more subband group indexes are configured using a medium access control message.

Aspect 46: The method of Aspect 38, further comprising configuring the UE with one or more subband group indexes and one or more cell indexes associated with a scheduled cell set indicator and a scheduled cell indicator, wherein the one or more subband group indexes are configured prior to the one or more cell indexes.

Aspect 47: The method of Aspect 46, further comprising configuring the UE with an information element that includes one or more entries indicating one or more combinations of one or more lists of subband groups that are configured to be scheduled and one or more subband groups that are scheduled.

Aspect 48: The method of Aspect 46, wherein a scheduled cell set DCI field and a scheduled cell indicator DCI field are configured as a scheduled subband group set indicator and a scheduled subband group indicator field, respectively, in the DCI, wherein the scheduled cell set DCI field and the scheduled cell indicator DCI field indicate corresponding entries within an information element and indicate a set of subband groups of a plurality of subband groups that are to be scheduled, wherein each subband group is associated with a cell of a plurality of virtual cells configured at the UE.

Aspect 49: The method of Aspect 46, further comprising configuring the UE with information that enables the UE to determine whether the UE is being scheduled by FSI or CA based at least in part on whether the UE is configured with a DCI indicator that indicates a set of subband groups or with a DCI indicator that indicates a set of cells.

Aspect 50: The method of Aspect 49, further comprising configuring the UE with both the DCI indicator that indicates the set of subband groups and the DCI indicator that indicates the set of cells, and further comprising configuring the UE with information that enables the UE to determine whether one or more cells being scheduled are indicated in a frequency domain resource allocation field or in a scheduled cell indicator field of the DCI.

Aspect 51: The method of Aspect 46, further comprising configuring the UE with one or more DCI parameters for configuring a physical downlink shared channel (PDSCH) communication or a physical uplink shared channel (PUSCH) communication with FSI or CA, wherein the one or more DCI parameters include at least one of a redundancy version (RV) index indicator or a modulation and coding scheme (MCS) indicator.

Aspect 52: The method of Aspect 51, wherein, based at least in part on the DCI including FSI, configuring the UE with a single RV index for single-transport-block scheduling or is configured with multiple RV indexes for multiple-transport-block scheduling.

Aspect 53: The method of Aspect 51 wherein, based at least in part on the DCI including CA, configuring the UE with a single RV index for each component carrier of a plurality of component carriers and for each transport block of a plurality of transport blocks.

Aspect 54: The method of Aspect 51, wherein one or more blocks of redundancy version (RV) indexes are signaled to the UE, and wherein the configuration information includes one or more rules that indicate whether the PDSCH communication or the PUSCH communication is scheduled with FSI or CA.

Aspect 55: The method of Aspect 54, wherein the DCI includes a flag that indicates whether the PDSCH communication or the PUSCH communication is configured with FSI or CA, wherein the UE is configured with information indicating that only one of the first DCI format or the second DCI format is enabled, wherein the UE is configured with an implicit indication using a search space index, a control resource set index, or a plurality of radio network temporary identifiers for a scrambling of a PDCCH cyclic redundancy check for FSI and CA, or wherein a quantity of demodulation reference signal ports included in the PDSCH communication or the PUSCH communication is configured to be used by the UE to obtain a quantity of layers.

Aspect 56: The method of any of Aspects 32-55, wherein a transport block is configured per component carrier mapping of a plurality of component carrier mappings, wherein the transport block is mapped to one or more subbands and is mapped to a single virtual cell, and wherein the UE is configured with information that enables the UE to determine a part of each transport block that is mapped to each subband group to retrieve the transport block.

Aspect 57: The method of Aspect 56, wherein the transport block is split into at least a first transport block part and a second transport block part, and wherein the DCI schedules at least one of the first transport block part or the second transport block part for multiple subband groups.

Aspect 58: The method of Aspect 56, wherein a single DCI schedules a plurality of transport blocks in different virtual cells, and wherein different parts of each transport block are configured to be mapped to a single subband group or to multiple subband groups in different component carriers that belong to a virtual cell of a set of different virtual cells.

Aspect 59: The method of any of Aspects 32-58, further comprising configuring the UE with DCI that schedules a transport block based at least in part on transmitting different parts of the transport block in one or more subband groups, and wherein the UE is configured to obtain information regarding one or more parts of the transport block of a plurality of parts of the transport block that are being scheduled.

Aspect 60: The method of Aspect 59, wherein one or more coded modulated data tones are allocated to one or more subbands using a frequency-first and time-second configuration, and wherein the UE is configured to retrieve an entirety of the transport block by sorting a plurality of transport block parts in accordance with a lowest resource block index or an absolute frequency location of each subband and in accordance with a physical downlink shared channel reception start time.

Aspect 61: The method of Aspect 59, further comprising transmitting a transport block part indicator field that includes one or more transport block part indicators.

Aspect 62: The method of Aspect 61, wherein the transport block part indicator field indicates one or more blocks corresponding to a plurality of subband groups or to a plurality of transport blocks within each block, and wherein different transport blocks within each block are arranged in ascending order using a subband group index, a cell index, and a transport block index.

Aspect 63: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-62.

Aspect 64: An apparatus for wireless communication at a device, the apparatus comprising one or more memories and one or more processors coupled to the one or more memories, the one or more processors configured to cause the device to perform the method of one or more of Aspects 1-62.

Aspect 65: An apparatus for wireless communication, the apparatus comprising at least one means for performing the method of one or more of Aspects 1-62.

Aspect 66: A non-transitory computer-readable medium storing code for wireless communication, the code comprising instructions executable by one or more processors to perform the method of one or more of Aspects 1-62.

Aspect 67: A non-transitory computer-readable medium storing a set of instructions for wireless communication, the set of instructions comprising one or more instructions that, when executed by one or more processors of a device, cause the device to perform the method of one or more of Aspects 1-62.

Aspect 68: A device for wireless communication, the device comprising a processing system that includes one or more processors and one or more memories coupled with the one or more processors, the processing system configured to cause the device to perform the method of one or more of Aspects 1-62.

Aspect 69: An apparatus for wireless communication at a device, the apparatus comprising one or more memories and one or more processors coupled to the one or more memories, the one or more processors individually or collectively configured to cause the device to perform the method of one or more of Aspects 1-62.

Aspect 70: A device comprising a processing system that includes one or more processors and one or more code-storing memories coupled with the one or more processors, the processing system configured to cause the device to perform the method of one or more of Aspects 1-62.

Aspect 71: A device comprising a processing system that includes processor circuitry and code-storing memory circuitry, the processing system configured to cause the device to perform the method of one or more of Aspects 1-62.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus configured for wireless communication, comprising:
one or more memories comprising processor-executable instructions; and
one or more processors configured to execute the processor-executable instructions and cause the apparatus to:
receive configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA;
receive a physical downlink control channel (PDCCH) communication that includes DCI having the first DCI format or DCI having the second DCI format; and
communicate with a network node in accordance with the DCI.

2. The apparatus of claim 1, wherein the first DCI format is configured to indicate only FSI and a third DCI format is configured to indicate only CA, wherein the apparatus is configured to identify whether the DCI has the first DCI format or the third DCI format in accordance with one or more parameters.

3. The apparatus of claim 1, wherein the configuration information indicates that the DCI has the first DCI format, and wherein one or more fields of the DCI indicate an FSI configuration of the apparatus.

4. The apparatus of claim 3, wherein the one or more fields of the DCI that indicate the FSI configuration of the apparatus include at least one of a frequency domain resource allocation (FDRA) field, a modulation and coding scheme (MCS) field, a time domain resource allocation (TDRA) field, a scheduled cell set and scheduled cell indicator field, a redundancy version (RV) index field, a new data indicator (NDI) field, or a hybrid automatic repeat request (HARQ) process number (HPN) field.

5. The apparatus of claim 4,
wherein the FDRA field indicates that an FDRA includes one or more blocks of bits,
each block of bits of the one or more blocks of bits indicating a frequency assignment for a subband of a plurality of subbands configured at the apparatus,
wherein the MCS field indicates one or more entries in one or more MCS tables for FSI,
wherein the TDRA field indicates one or more entries in one or more TDRA tables,
wherein the scheduled cell set and scheduled cell indicator field indicates a subband set and a combination of subbands within the subband set that are configured for physical uplink shared channel communications or physical downlink shared channel communications,
wherein the RV index field indicates a single RV index for each transport block associated with FSI,
wherein the NDI field is signaled for each transport block of a plurality of transport blocks, and
wherein the HPN field is signaled for each subband group of a plurality of subband groups or is signaled for each set of subband groups of a plurality of sets of subband groups within a virtual cell.

6. The apparatus of claim 1, wherein the configuration information indicates that the DCI has the second DCI format.

7. The apparatus of claim 6, wherein the DCI includes one or more bits that indicate whether the DCI is for FSI or CA.

8. The apparatus of claim 6, wherein the configuration information indicates one or more parameters for a configuration of a search space or a control resource set for FSI and CA, or the configuration information indicates one or more radio network temporary identifiers for a physical downlink control channel (PDCCH) cyclic redundancy check scrambling for FSI and CA.

9. The apparatus of claim 6, wherein the apparatus is configured with one or more cell indexes and one or more subband group indexes associated with a scheduled cell set indicator and a scheduled cell indicator, wherein the one or more cell indexes are configured before the one or more subband group indexes are configured.

10. The apparatus of claim 9, wherein one or more combinations of the one or more cell indexes and the one or more subband group indexes are configured using a joint radio resource control configuration, wherein the one or more combinations of the one or more cell indexes includes a combination of one or more subbands or blocks per cell index.

11. The apparatus of claim 9, wherein one or more combinations of the one or more cell indexes are configured using a radio resource control configuration and the one or more subband group indexes are configured using a DCI indicator.

12. The apparatus of claim 9, wherein one or more combinations of the one or more cell indexes are configured using a radio resource control configuration and the one or more subband group indexes are configured using a medium access control message.

13. The apparatus of claim 6, wherein the apparatus is configured with one or more subband group indexes and one or more cell indexes associated with a scheduled cell set indicator and a scheduled cell indicator, wherein the one or more subband group indexes are configured prior to the one or more cell indexes.

14. The apparatus of claim 13, wherein a scheduled cell set DCI field and a scheduled cell indicator DCI field are configured as a scheduled subband group set indicator and a scheduled subband group indicator field, respectively, in the DCI, wherein the scheduled cell set DCI field and the scheduled cell indicator DCI field indicate corresponding entries within an information element and indicate a set of subband groups of a plurality of subband groups that are to be scheduled, wherein each subband group is associated with a cell of a plurality of virtual cells configured at the apparatus.

15. The apparatus of claim 13, wherein the apparatus is configured to determine whether the apparatus is being scheduled by FSI or CA based at least in part on whether the apparatus is configured with a DCI indicator that indicates a set of subband groups or with a DCI indicator that indicates a set of cells.

16. The apparatus of claim 13, wherein the apparatus is configured with one or more DCI parameters for configuring a physical downlink shared channel (PDSCH) communication or a physical uplink shared channel (PUSCH) communication with FSI or CA, wherein the one or more DCI parameters include at least one of a redundancy version (RV) index indicator or a modulation and coding scheme (MCS) indicator.

17. The apparatus of claim 16, wherein, based at least in part on the DCI including FSI, the apparatus is configured with a single RV index for single-transport-block scheduling or is configured with multiple RV indexes for multiple-transport-block scheduling.

18. The apparatus of claim 16, wherein, based at least in part on the DCI including CA, the apparatus is configured with a single RV index for each component carrier of a plurality of component carriers and for each transport block of a plurality of transport blocks.

19. An apparatus configured for wireless communication, comprising:
one or more memories comprising processor-executable instructions; and
one or more processors configured to execute the processor-executable instructions and cause the apparatus to:
transmit configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA;
transmit a physical downlink control channel (PDCCH) communication that includes DCI having the first DCI format or DCI having the second DCI format; and
communicate with a user equipment (UE) in accordance with the DCI.

20. A method of wireless communication performed by a user equipment (UE), comprising:
receiving configuration information that indicates a first downlink control information (DCI) format and a second DCI format, wherein the first DCI format is configured to indicate only one of flexible spectrum integration (FSI) or carrier aggregation (CA) and the second DCI format is configured to indicate both FSI and CA;
receiving a physical downlink control channel (PDCCH) communication that includes DCI having the first DCI format or DCI having the second DCI format; and
communicating with a network node in accordance with the DCI.
